(19) United States
(12) Patent Application Publication
(10) Pub. No.: US 2011/0004412 A1
(43) Pub. Date: Jan. 6, 2011

(54) CLINICAL APPLICATIONS OF NEUROPSYCHOLOGICAL PATTERN ANALYSIS AND MODELING

(75) Inventors: Goded Shahaf, Haifa (IL); Guy Ben-Bassat, Kibbutz Beit Zera - Doar-Na Emek HaYarde (IL); Urit Gordon, Kiryat-Tivon (IL); Amir B. Geva, Tel-Aviv (IL); Amit Reches, Haifa (IL); Ayelet Kanter, Yokneam Ilit (IL); Noga Pinchuk, Zikhron-Yaakov (IL)

Correspondence Address: MARTIN D. MOYNIHAN d/b/a PRTSI, INC., P.O. BOX 16446, ARLINGTON, VA, 22215, US

(73) Assignee: ELMINDA LTD.

(21) Appl. No.: 12/745,559

(22) PCT Filed: Nov. 30, 2008
(86) PCT No.: PCT/IL08/01560

§ 371 Date: Sep. 20, 2010

Related U.S. Application Data
(60) Provisional application No. 60/990,966, filed on Nov. 29, 2007.
(60) Provisional application No. 61/058,578, filed on Jun. 4, 2008.
(60) Provisional application No. 61/097,880, filed on Sep. 18, 2008.

(51) Int. Cl. G06F 19/00; G06E 3/00

(52) U.S. Cl. 702/19; 706/18; 706/20

(57) ABSTRACT

A method for functional analysis of neurophysiological data by decomposing neurophysiological data and EEG signal to form a plurality of signal features. The signal features may then optionally be analyzed to determined one or more patterns.

### FIELD OF THE INVENTION

The present invention relates to methods of applying models neuropsychological data and/or analyses of patterns of neurophysiological data in a clinical setting.

### BACKGROUND OF THE INVENTION

It is known in the field of neuropsychology that behavioral functions are based upon flow among various functional regions in the brain, involving specific spatiotemporal flow patterns. Likewise, behavioral pathologies are often indicated by a change in the patterns of flow. The specific spatiotemporal pattern underlying a certain behavioral function or pathology is composed of functional brain regions, which are often active for many tens of milliseconds and more. The flow of activity among those regions is often synchronization-based, even at the millisecond level and sometimes with specific time delays.

Various pathologies are known to affect such flows between regions of the brain; indeed, for some types of pathologies, an absence of a flow or a particular brain activity may also be found. Furthermore, administering one or more treatments to the brain, whether pharmacological, surgical or rehabilitative in nature, may also affect such flows.

Models are commonly used in the field of neurology to gain understanding about the behavioral functions of the various regions of the brain and their interaction or flow, producing these spatiotemporal flow patterns. Understanding of the spatiotemporal pattern may be gained by using models. However, to date it has been difficult to construct and test a unifying model able to explain observations relating to more than one specific region of the brain. It has therefore also been difficult to determine the effect of a particular pathology and/or treatment, and certainly is very difficult to predict the effect of a particular pathology and/or treatment on the brain in advance.

### SUMMARY OF THE INVENTION

The background art does not teach or suggest a method for applying a neural model which has predictive value in a clinical setting. The background art also does not teach or suggest a method for predicting the effect of a particular pathology and/or treatment on the brain in advance by using such a model.

The present invention overcomes these drawbacks of the background art by providing a method for applying a predictive neural model in a clinical setting. The predictive neural model is preferably able to predict the effect of a particular pathology and/or treatment on the brain in advance. Optionally (and alternatively or additionally) a simulation of the effect of a particular pathology and/or treatment on the brain is preferably performed by using the neural model. The neural model preferably includes neurophysiological and neuropsychological data. As used herein, the term “treatment” preferably includes one or more of pharmacological, surgical or rehabilitative interventions. Also as defined herein, the term “neural model” also includes at least one analyzed pattern, which may also optionally form part of the model itself and/or may actually be the model itself.

Neurophysiological data includes any type of signals obtained from the brain. Such signals may be measured through such tools as EEG (electroencephalogram), which is produced using electroencephalography. Electroencephalography is the neurophysiologic measurement of the electrical activity of the brain (actually voltage differences between different parts of the brain), performed by recording from electrodes placed on the scalp or sometimes in or on brain tissue. As used herein, the term “neurophysiological data” also refers to brain imaging tools, including but not limited to CT (computed tomography) scans, PET (positron emission tomography) scans, magnetic resonance imaging (MRI) and functional magnetic resonance imaging (fMRI), ultrasound and single photon emission computed tomography (SPECT).

Optionally and preferably, the model also features neuropsychological data, for example from a knowledgebase or any type of database. The information may optionally be obtained from literature and/or from previous studies, including studies performed according to one or more aspects of the present invention, for example as described herein and/or as described in PCT Application No. PCT/IL2007/000639, by the present inventors and owned in common with the present application.

The present invention also encompasses a system and method for predicting an effect of a pathology and/or treatment by using a comprehensive neural modeling platform. An embodiment of the present invention provides for a platform able to analyze, test and integrate different models. Optionally and preferably the comprehensive modeling platform of the present invention provides a neural model knowledgebase that may be defined and updated. Optionally and preferably the knowledgebase is based on published data and experimental data. Optionally and preferably the knowledgebase may be organized by function or location.

According to some embodiments of the present invention, the predictive effect is determined according to pattern analysis of source localization data.

It should be noted that the clinical predictive effect provided by a model and/or pattern analysis may optionally be obtained through entailment rather than through direct causation. By “entailment” it is meant that a particular model and/or pattern may optionally be predictive for success of a certain treatment and/or as an effect of a certain treatment and/or pathology; however, this predictive effect does not mean that the model and/or pattern is related to actual causation.

Optionally, a clinical model may be examined even without doing many trials on subjects such as actual patients. If the correct model has been prepared (and if it is known to be correct), then fewer trials are required. Such models are available for diagnosis and testing of various physiological models, for example for pharmaceuticals. Providing such clinical models in the context of neuropsychology requires the provision of additional data and potentially greater testing initially.

Among the many advantages of the present invention is that the predictive clinical effect may optionally be determined regardless of whether the patient is capable of a particular voluntary action, such as a particular motion for example. For patients with particular trauma and/or diseases, one or more types of voluntary actions may no longer be performable. Currently available testing is not operative under such circumstances, as it relies upon these voluntary actions. Thus, according to preferred embodiments of the present invention, there is provided a method for testing patients who are incapable of performing one or more voluntary actions.

According to preferred embodiments of the present invention, there is provided a method for determining an effect of a treatment on a patient, comprising applying a neural model and/or pattern analysis to neurophysiological and/or neuropsychological data obtained from the patient, before and after treatment; and comparing the neural model and/or pattern analysis before and after treatment to determine the effect of the treatment.

According to other preferred embodiments of the present invention, there is provided a method for predicting an effect of a treatment on a patient, comprising applying a neural model and/or pattern analysis to neurophysiological and/or neuropsychological data obtained from the patient before treatment; and comparing the neural model and/or pattern analysis to neural model and/or pattern analysis to neurophysiological and/or neuropsychological data obtained from one or more patients after treatment to predict the effect of the treatment.

Optionally, the neural model and/or pattern analysis to neurophysiological and/or neuropsychological data obtained from one or more patients after treatment may comprise an abstraction of such neural models and/or pattern analyses from a plurality of patients.

The above methods may optionally be used for example in a clinical trial, to determine the efficacy of a particular treatment and preferably relate to one or more endpoints of the clinical trial.

The above methods may also optionally be used for example to select the best intervention for a patient, whether such an intervention is the best pharmaceutical treatment, the best surgical treatment and/or the best rehabilitative treatment, and/or a combination thereof, or no intervention, in order to provide personalized medicine and treatment management for the individual. Such methods are also expected to improve research for new interventions and/or for selecting the best invention(s) for any particular disease and/or trauma.

Without wishing to be limited by particular diseases and conditions, preferably at least some embodiments of the present invention are related to stroke, ADHD (attention deficit hyperactivity disorder)/ADD (attention deficit disorder), traumatic brain injuries, PTSD (post traumatic stress disorder) and pain management.

Although the present description centers around the use of models and pattern analyses constructed by using EEG data, it should be noted that this is for the purpose of illustration only and is not meant to be limiting in any way. Any type of brain imaging data may optionally be used, including but not limited to CT (computed tomography) scans, PET (positron emission tomography) scans, magnetic resonance imaging (MRI) and functional magnetic resonance imaging (fMRI), ultrasound, MEG (magnetoencephalography) and single photon emission computed tomography (SPECT), or any other noninvasive or invasive method and/or combinations thereof. Optionally, a plurality of different types of data may be combined for determining one or more models as described herein.

Also although the present invention centers around a description of human patients, it should be noted that any subject could optionally be used, preferably including any type of mammal.

According to some embodiments of the present invention, there is provided a method for predicting an effect of a treatment, comprising obtaining a neural model for a subject, wherein the neural model comprises neurophysiological data, and predicting the effect according to the neural model. Preferably, the neural model comprises at least one analyzed pattern of the neurophysiological data. More preferably, the analyzed pattern comprises a plurality of causally related features. Most preferably, the analyzed pattern comprises a plurality of features related through entailment. Optionally and most preferably, additional neurophysiological data is obtained from a plurality of subjects before and after the treatment, such that the neural model is constructed according to the additional neurophysiological data with regard to the treatment. Also most preferably, the predicting the effect further comprises comparing the additional neurophysiological data to the neurophysiological data from the subject; and determining a similarity between the additional neurophysiological data and the neurophysiological data.

Optionally the method further comprises establishing a tolerance for the similarity to predict the effect of the treatment. Preferably, the method further comprises performing at least one additional test on the subject and repeating the comparing the additional neurophysiological data to the neurophysiological data from the subject.

Optionally the method further comprises performing a clinical trial on a plurality of subjects to ratify the neural model. Also optionally, the method further comprises designing a clinical trial to be performed on a plurality of subjects to test a new therapy according to the neural model. Preferably, at least one therapeutic endpoint is determined according to the neural model.

Optionally the neurophysiological data is obtained from the subject with regard to performing a task. Preferably, the subject actually performs the task. Alternatively and preferably, the subject conceptualizes performing the task. More preferably, the subject is in a designated treatment environment when collecting the neurophysiological data.

Optionally the subject is incapable of performing one or more voluntary actions.

Also optionally the treatment comprises neural feedback. Preferably, the neural feedback increases functional plasticity. More preferably, the neural feedback comprises a treatment selected from the group consisting of EMG (electromyography) biofeedback, EEG neurofeedback (NF), TMS (transcranial magnetic stimulation) and direct electrode stimulation.

Optionally, the method further comprises selecting the best intervention for a patient. Preferably, the best intervention comprises one or more of the best pharmaceutical treatment, the best surgical treatment and/or the best rehabilitative treatment, and/or a combination thereof, or no intervention.

Optionally the above method is used for providing personalized medicine to a patient.

According to other embodiments of the present invention, there is provided a method for managing treatment for an individual patient, comprising selecting a treatment according to any of the above methods.

According to still other embodiments of the present invention, there is provided a method for performing a clinical trial for a treatment, comprising obtaining a neural model and/or pattern analysis for a plurality of subjects, separating the subjects into treatment and control groups, performing or not performing at least one treatment accordingly and determining an effect of the treatment on subjects in the treatment group.

Optionally the treatment comprises one or more of pharmacological, surgical or rehabilitative interventions.

Optionally the neurophysiological data comprises one or more of EEG (electroencephalogram) signal data, CT (computed tomography) scan data, PET (positron emission tomography) scan data, magnetic resonance imaging (MRI) data and functional magnetic resonance imaging (fMRI) data, ultrasound data, and single photon emission computed tomography (SPECT) data. Preferably, the neurophysiological data comprises source localization data.

Optionally the treatment is for a disease selected from the group consisting of stroke, ADHD (attention deficit hyperactivity disorder)/ADD (attention deficit disorder), traumatic brain injuries, PTSD (post traumatic stress disorder) and pain management.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWINGS

The above and further advantages of the present invention may be better understood by referring to the following description in conjunction with the accompanying drawings in which:

FIG. 1 shows a flowchart of an exemplary, illustrative non-limiting method for subject classification according to the present invention;

FIG. 2A shows a flowchart of an exemplary, illustrative non-limiting method for selection of treatment according to the present invention, while FIG. 2B relates to exemplary patterns of brain activity which could optionally be used in the method of FIG. 2A;

FIG. 3 relates to an exemplary, illustrative separation of subjects into a plurality of groups according to the method of FIG. 1;

FIG. 4 shows a flowchart of an exemplary, illustrative non-limiting method for performing a clinical trial of a treatment according to the present invention;

FIG. 5 shows an exemplary, illustrative method for a neurological treatment according to the present invention;

FIG. 6 shows an exemplary screenshot of an exemplary, illustrative non-limiting graphical user interface (GUI) for providing feedback to a subject according to FIG. 5;

FIG. 7 shows a graph of results following neural feedback performed according to the method of FIG. 6;

FIGS. 8A and 8B relate to change(s) in the anticipatory pattern of a subject before and after neural feedback performed according to the method of FIG. 6;

FIG. 9 relates to differences in brain patterns seen in patients without pain (left panel) and suffering from pain (right panel);

FIG. 10 illustrates these different patterns and their combinations graphically;

FIG. 11 relates to network changes observed in four patients as a result of treatment with neural feedback;

FIG. 12 relates to the percent improvement in the FM/BB tests;

FIG. 13A shows the combined EMG and FM/BB results after treatment, while FIGS. 13B and 13C show exemplary source localizations;

FIG. 14 relates to improvement of BIT and SNT RT scores after treatment;

FIG. 15 shows the correlation between the post-treatment target and the desired target network in terms of treatment efficacy;

FIG. 16 shows the correlation between muscle activation and network activation; and

FIG. 17 demonstrates the ability of the method of the present invention to correlate a neuropsychological process with functional network activation.

It will be appreciated that for simplicity and clarity of illustration, elements shown in the drawings have not necessarily been drawn accurately or to scale. For example, the dimensions of some of the elements may be exaggerated relative to other elements for clarity or several physical components may be included in one functional block or element. Further, where considered appropriate, reference numerals may be repeated among the drawings to indicate corresponding or analogous elements. Moreover, some of the blocks depicted in the drawings may be combined into a single function.

### DETAILED DESCRIPTION

In the following detailed description, numerous specific details are set forth in order to provide a thorough understanding of the present invention. It will be understood by those of ordinary skill in the art that the present invention may be practiced without these specific details. In other instances, well-known methods, procedures, components and structures may not have been described in detail so as not to obscure the present invention.

The present invention is directed in some embodiments to a system and method for clinical applications of neural modeling of neuropsychological processes and/or neurophysiological data and/or pattern analysis for neurophysiological data. The principles and operation of methods according to the present invention may be better understood with reference to the drawings and accompanying descriptions.

Before explaining at least one embodiment of the present invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein are for the purpose of description and should not be regarded as limiting.

The present invention, in some embodiments, is directed to a platform that may be used for test groups or individual subjects, to provide models that explain observed brain activity or neuropsychological patterns, related to behavior, and/or for pattern analysis of neurophysiological data, for clinical applications. The clinical applications optionally include but are not limited to determining a diagnosis and/or diagnostic category for a patient, determining one or more additional tests to be performed on the patient, selecting one or more treatments for the patient and/or for predicting the effect of treatment on a patient.

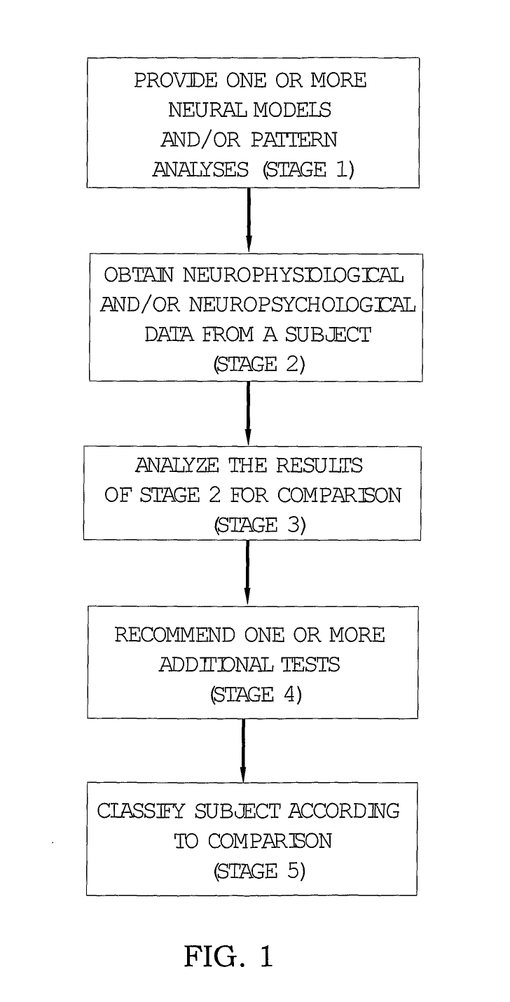

FIG. 1 shows a flowchart of an exemplary, illustrative non-limiting method for subject classification according to the present invention. As shown, in stage 1 one or more neural models and/or pattern analyses are provided as previously described. The neural model(s) and/or pattern analyses may optionally be obtained as described for example obtained from the application entitled “FUNCTIONAL ANALYSIS OF NEUROPHYSIOLOGICAL DATA” and/or from the application entitled “NEUROPSYCHOLOGICAL MODELING”, both of which are co-filed by the present inventors and owned in common with the present application, the contents of both of which are hereby incorporated by reference as if fully set forth herein.

In stage 2, neurophysiological and/or neuropsychological data from a subject is obtained. Preferably such data includes data that is obtained while a subject is performing a task and/or is requested to perform a task. Because the present invention does not rely only on data related to performance of an actual task, the conceptualization of performing a task by the subject may optionally be used in addition to, or instead of, actual performance of the task itself.

Preferably the data includes EEG data.

In stage 3, the results of stage 2 are analyzed for comparison according to the one or more neural models and/or pattern analyses of stage 1. For example, a particular pattern of source localization obtained from an EEG of the subject may optionally be found to be comparable to the one or more neural models and/or pattern analyses. By comparable it is preferably meant that at least certain features (whether in their presence or absence) are found both in the data obtained from the subject and also in the provided one or more neural models and/or pattern analyses. The degree to which such feature(s) match or are identical is preferably predetermined according to a range of tolerance.

Optionally, in stage 4, one or more additional tests are recommended, preferably if for example an exact comparison is not possible because of missing information. The tests may optionally be neurophysiological and/or neuropsychological in nature and more preferably include at least one EEG performed while the subject is request to at least mentally conceptualize performing a particular task.

In stage 5, the subject is preferably classified according to the above comparison. Such a classification may optionally for example be related to a particular diagnosis.

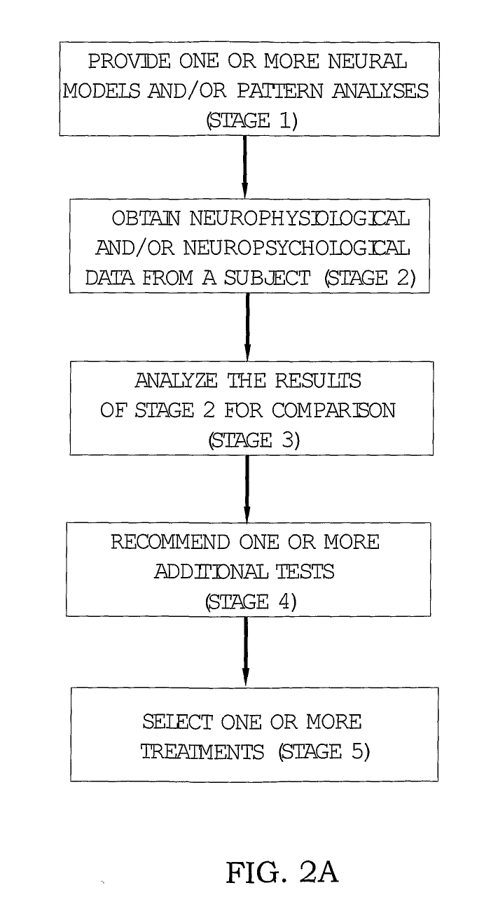

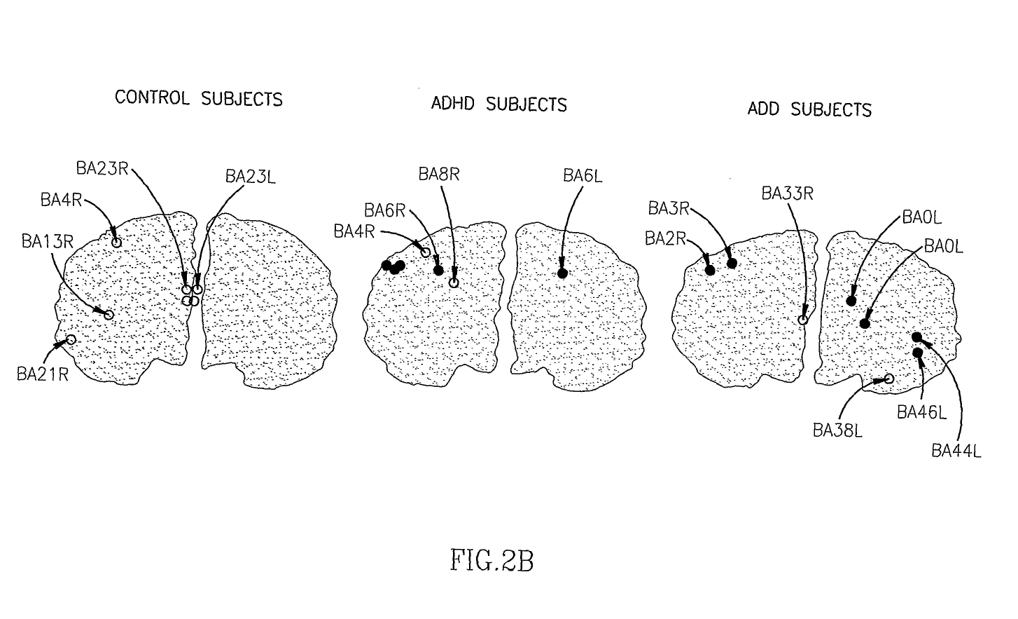

FIG. 2A shows a flowchart of an exemplary, illustrative non-limiting method for selection of treatment according to the present invention. As shown, in stage 1 one or more neural models and/or pattern analyses are provided as previously described. The neural model(s) and/or pattern analyses may optionally be obtained as described for example obtained from the application entitled “FUNCTIONAL ANALYSIS OF NEUROPHYSIOLOGICAL DATA” and/or from the application entitled “NEUROPSYCHOLOGICAL MODELING”, both of which are co-filed by the present inventors and owned in common with the present application, the contents of both of which are hereby incorporated by reference as if fully set forth herein.

In stage 2, neurophysiological and/or neuropsychological data from a subject is obtained. Preferably such data includes data that is obtained while a subject is performing a task and/or is requested to perform a task. Because the present invention does not rely only on data related to performance of an actual task, the conceptualization of performing a task by the subject may optionally be used in addition to, or instead of, actual performance of the task itself.

Preferably the data includes EEG data.

In stage 3, the results of stage 2 are analyzed for comparison according to the one or more neural models and/or pattern analyses of stage 1. For example, a particular pattern of source localization obtained from an EEG of the subject may optionally be found to be comparable to the one or more neural models and/or pattern analyses. By comparable it is preferably meant that at least certain features (whether in their presence or absence) are found both in the data obtained from the subject and also in the provided one or more neural models and/or pattern analyses. The degree to which such feature(s) match or are identical is preferably predetermined according to a range of tolerance.

Optionally, in stage 4, one or more additional tests are recommended, preferably if for example an exact comparison is not possible because of missing information. The tests may optionally be neurophysiological and/or neuropsychological in nature and more preferably include at least one EEG performed while the subject is request to at least mentally conceptualize performing a particular task.

In stage 5, one or more treatments are selected according to the above described comparison. For example, the above described comparison could optionally be made with models and/or pattern analyses obtained from test subjects who then did or did not receive a certain treatment, to determine the effect of the treatment. As noted above, the treatment may optionally and preferably comprise one or more of pharmacological, surgical and/or rehabilitative treatments. Such treatments may also optionally include (additionally or alternatively) direct brain activation, for example through magnetic or electrical stimulation.

FIG. 2B relates to exemplary patterns of brain activity which could optionally be used in the method of FIG. 2A. As shown, brain activity patterns may be obtained from control (left panel), ADHD subjects (middle panel) and ADD subjects (right panel). An auditory go/no go task was used. The control subjects show a simple response/activation pattern. The ADHD subjects show heavy and highly synchronized motor and sensory-motor activation. The ADD subjects show wide pre-frontal activity (inhibition involved) and para-amygdalar activation (emotional element). These differences are illustrative of those which may optionally be used to select a treatment, as well as to make an accurate diagnosis.

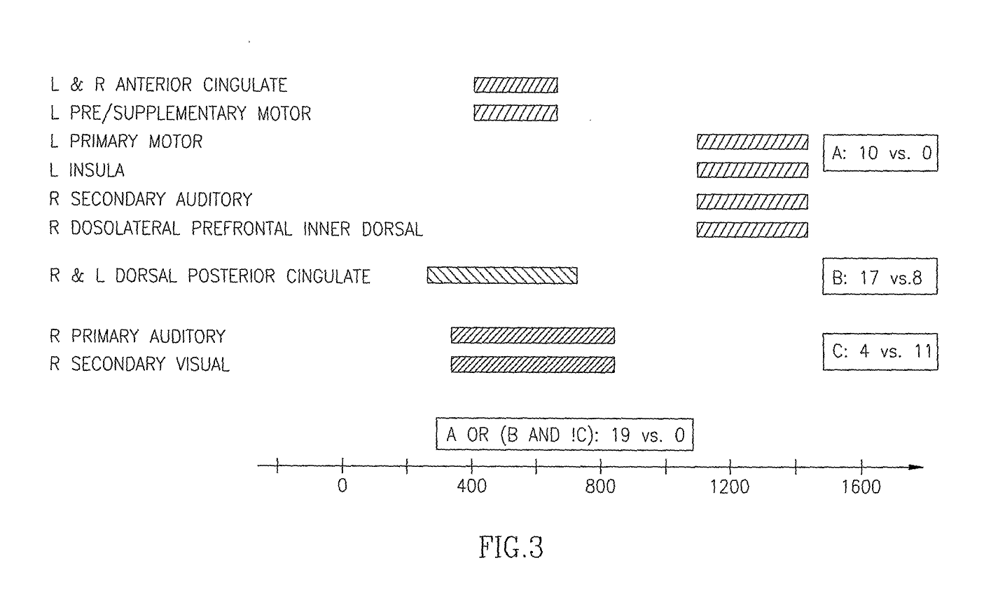

FIG. 3 relates to an exemplary, illustrative separation of subjects into a plurality of groups according to the method of FIG. 1. As shown, the subjects are separated according to a combination of patterns which identifies response to pain with 100% specificity and sensitivity (19/19 for response to a painful stimulus vs. 0/19 for painless stimuli). The separation was made on the basis of patterns obtained from analysis of actual experimental data. The analysis results of the dataset identified three patterns, A in green, B in blue and C in red. The elements of the patterns are presented at the Y axis; for each element, temporal tolerance is presented at the X axis (in milliseconds). The numbers near the pattern headers represent their number of occurrences in two experimental groups. Note that while each pattern discriminates between the groups by a given degree, their combination as A OR (B and NOT C) discriminates between the groups completely (each group contains 19 experiments).

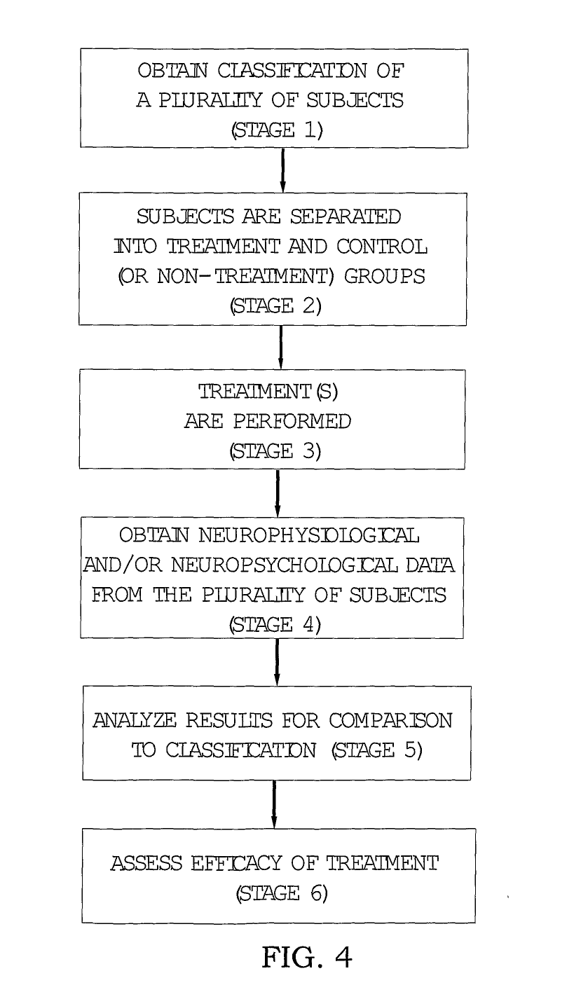

FIG. 4 shows a flowchart of an exemplary, illustrative non-limiting method for performing a clinical trial of a treatment according to the present invention. In stage 1 as shown the classification for a plurality of subjects is preferably obtained, for example according to the method of FIG. 1. More preferably, the classification is such that the subjects fall into an identical or at least broadly similar group, such that an accurate comparison is possible.

In stage 2, the subjects are preferably separated into treatment and control (or non-treatment) groups. Optionally, more than one treatment group may be provided, for example to compare different treatments and/or different implementations of the same treatment (for example different dosages of a pharmaceutical treatment).

In stage 3, the treatments are performed, including any control activities for the control group.

In stage 4, neurophysiological and/or neuropsychological data from the plurality of subjects is obtained. Preferably such data includes data that is obtained while a subject is performing a task and/or is requested to perform a task. Because the present invention does not rely only on data related to performance of an actual task, the conceptualization of performing a task by the subject may optionally be used in addition to, or instead of, actual performance of the task itself. Preferably the data includes EEG data.

In stage 5, the results of stage 4 are preferably analyzed for comparison to the classification of the subjects before treatment (or before any control activities, if any).

In stage 6, the efficacy of the treatment is assessed on the basis of the comparison.

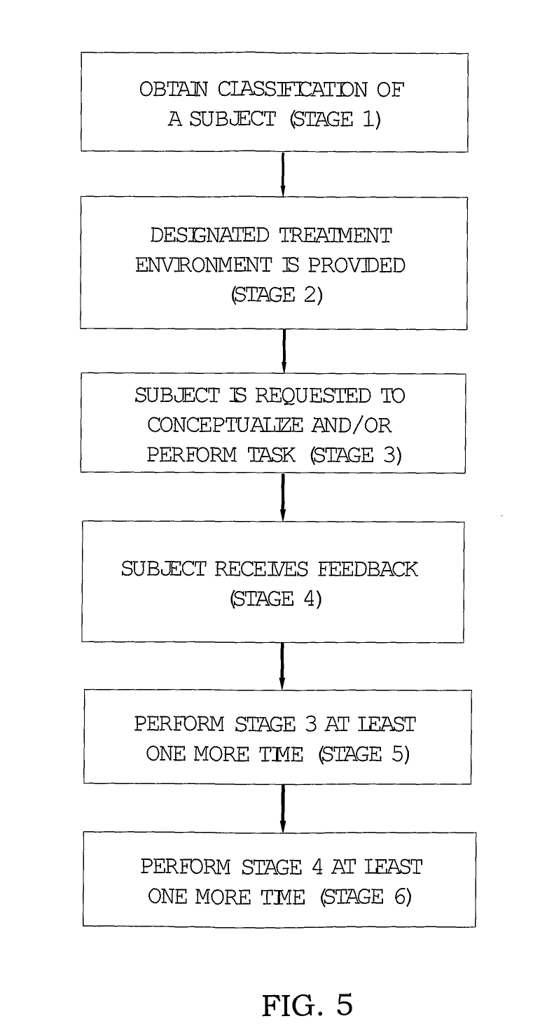

FIG. 5 shows an exemplary, illustrative method for a neurological treatment according to the present invention. As shown, in stage 1 the classification for a subject is obtained, for example according to the method of FIG. 1.

In stage 2, a designated treatment environment is preferably provided which is suitable for the subject according to the classification. The treatment environment preferably combines virtual reality and neurofeedback principles.

In stage 3, the subject (while in the designated treatment environment) is requested to at least conceptualize performing a particular task or tasks; more preferably the subject performs the task(s).

In stage 4, the subject receives feedback regarding such conceptualization and/or performance. The feedback is preferably related to eliciting one or more “hidden” patterns of neural activity, which are desired but which the subject is not able to initially access.

In stage 5, optionally and preferably stage 3 is performed at least one more time, if not a plurality of times. Preferably the initial (anticipatory) pattern of the subject shows improvement between repetitions. In stage 6, optionally and preferably stage 4 is performed at least one more time, if not a plurality of times. Such repetition(s) may optionally be performed until some desired endpoint is reached, such as a particular therapeutic outcome for example and/or a determination to perform one or more additional tests as another example.

Neural feedback may optionally be performed to enhance existing but damaged brain functions and capabilities. For these damaged functions, typically some functionality remains. Successful trials (ie test sessions) typically differ from failures in the additional network components which are able to operate. Those components can be internal or external to the original network. Basic rehabilitation is the internalization of those components to the network.

Alternatively neural feedback may seek to switch functionality to different parts of the brain, to a different “network”. This switch may be required if extensive damage is present and/or if residual function is not present. Often it will be based on using higher regions for previously automatic processing. There are also other alternative computation methods.

Treatment is preferably directed by using functional plasticity. The use of effective plasticity preferably involves identifying which networks and network components could be utilized by plasticity, thereby focusing functional plasticity by neural feedback to differ causality from epiphenomena. Also it involves identifying which procedures could be utilized in the process and directing the treatment accordingly.

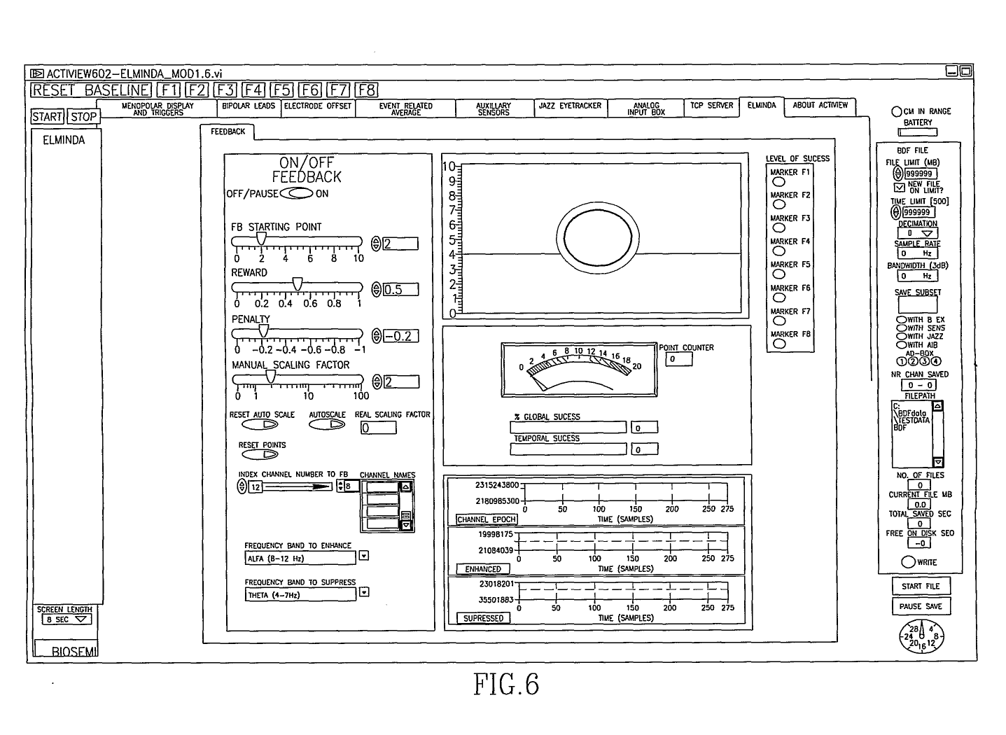

FIG. 6 shows an exemplary screenshot of an exemplary, illustrative non-limiting graphical user interface (GUI) for providing feedback to a subject according to FIG. 5. The feedback may optionally include any type of graphical and/or audible feedback. Preferably, when the subject succeeds in evoking a specific pattern of activity at specific loci, the subject receives visual and/or auditory feedback. For example, the tank on upper-right is filled with green in the GUI as an example of visual feedback.

The software described with regard to FIG. 6 may optionally be used to reveal general rules of plasticity and also the effect of rehabilitation on clinical patterns observed in a subject. The software may also optionally be used to provide a functional probe (neurofeedback) which reveals functional ability in the brain in terms of activating patterns, and preferably finding a method that closes loop upon patterns that are task/function related (ie increases the strength of desired patterns).

Turning now to the effect of rehabilitation, preferably it is possible to review the current state of an individual patient (described in this example as a stroke patient for the purpose of description only and without any intention of being limiting) and to predict which rehabilitation training is most suitable. Preferably, this goal is achieved by connecting patterns observed before and after rehabilitation training to the patterns exhibited during the training (which is a form of treatment).

For this work, EMG (electromyography) biofeedback (BF) improvement is preferably used as assessment tool for ability. It is assumed that peripheral training (treatment) can improve EMG BF, therefore ability. For patients who lack motor function, optionally direct training of the brain is performed, for example by using EEG neurofeedback (NF), and/or other methods (TMS (transcranial magnetic stimulation), direct electrode stimulation). Such methods could also optionally be used if be found to be more efficient. The state of the patient is preferably assessed before and after treatment with regard to some desired outcome or goal.

In order to establish that EMG BF is correlated with ability, preferably the influence of treatment methods is examined by using Fugel-Meyer score in beginning, middle, end and follow-up examinations or at least a portion thereof.

The above is preferably tested according to the following experimental structure. In each experiment there will be 3-4 parts:

Assessment (before treatment)—EMG biofeedback. The feedback parameter preferably is a complex of several electrodes. Feedback delivery is preferably delivered appropriately during the experiment. The feedback agent may optionally be connected to a functional task (such as raising hand video). Feedback is optionally provided through a single bipolar lead of raw EMG waves.

For treatment, various training methods are preferably used, including but not limited to mirror training, passive movements, tens, other general physiotherapy.

Assessment (after treatment) is preferably performed through EMG biofeedback.

Data analysis preferably enables a connection to be found between the patient's basic condition and ability, the treatment received, and the condition and ability reached by the end of treatment in different timescales. These plasticity processes are assumed to have identifiable patterns in EEG recording.

Analysis of the above data preferably leads to a determination of one or more rules of plasticity, for example including but not limited to analysis of common patterns before and after with/without during treatment. This method assumes that patterns that have strengthened in plasticity by the end of the testing process are affected by treatment.

The above is preferably performed by using the system and method of the present invention as described herein.

The software may also optionally be used to provide a functional probe, to find resolutions of patterns that are connected to a function. In stroke patients, it means finding the functional residue that can be activated in patterns that are task/function related. A higher level would be an ability to learn to induce activity of these patterns on request using a feedback.

Neural plasticity is often based on repetition and reward. In order to improve the performance in a behavioral task (a task which its success we can measure) it is desired to enhance brain activity that is related to the success in the task. To encourage specific activity of the brain, preferably feedback is repeatedly delivered to the subject upon this activity. Preferably, the correct resolution between a specific pattern and general brain activity is located, so as to encourage the desired behavior and to encourage brain plasticity. The goal or desired pattern preferably has a number of components including spatial—which electrodes participate in determining the goal pattern; temporal—time window of activation from audio/visual event relative to the stimulus (or to previous activity); frequency—range of band pass filter(s) applied to the signal; complexity—logic combinations of different activations.

The parameters of the feedback are preferably defined by how similar an observed pattern is to the goal pattern, for example according to a weighted value of each activity (assembled of electrodes, time window and frequency band); and/or according to a weighted value of each of the parameters, for all activities together (permissiveness of each ‘demand’: temporal, spatial, etc). The feedback is preferably one or more of visual, audible and/or tactile.

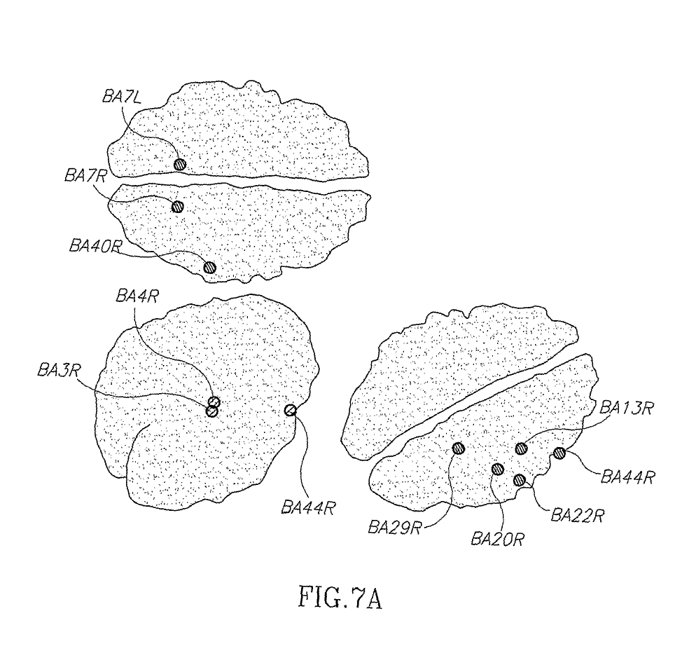

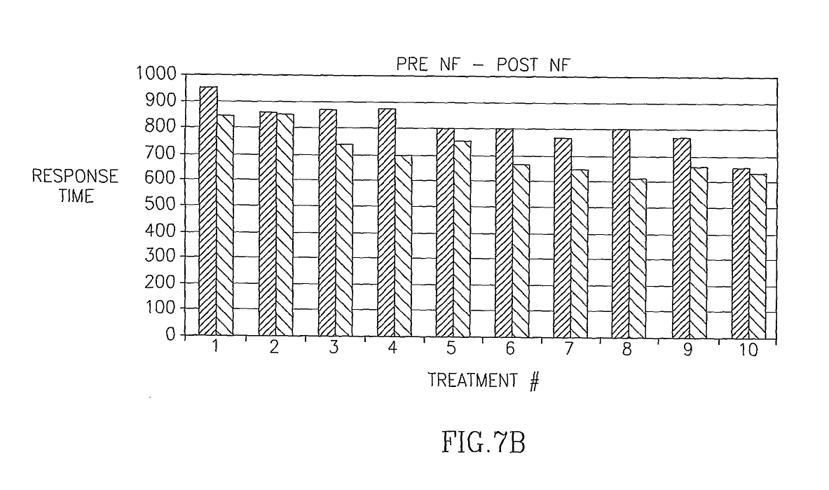

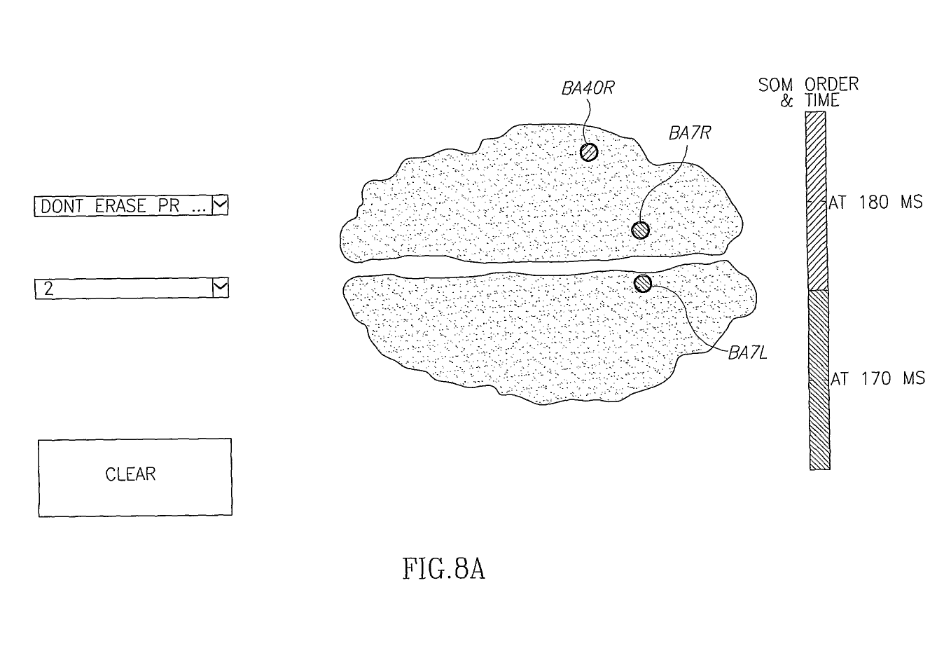

FIG. 7A shows before (top panel) and after (bottom panel) results after treatment of a stroke patient, optionally with the neural feedback method of the present invention but alternatively with another type of treatment method. The two panels reveal alternative connectivity pathways formed during stroke rehabilitation. The left and right brain patterns for the bottom panel show that alternative functional networks are revealed for the same spatial attention task following rehabilitation (neuroplasticity).

FIG. 7B shows a graph of results following neural feedback performed according to the method of FIG. 6. The results demonstrate an improvement in response time of spatial detection of stimulus. The results of ten daily treatments are presented for a subject suffering from spatial neglect (for example following a stroke). For each day, the response time before treatment is presented in blue and after treatment in red. Improvement is notable both daily and also after a plurality of days of treatment.

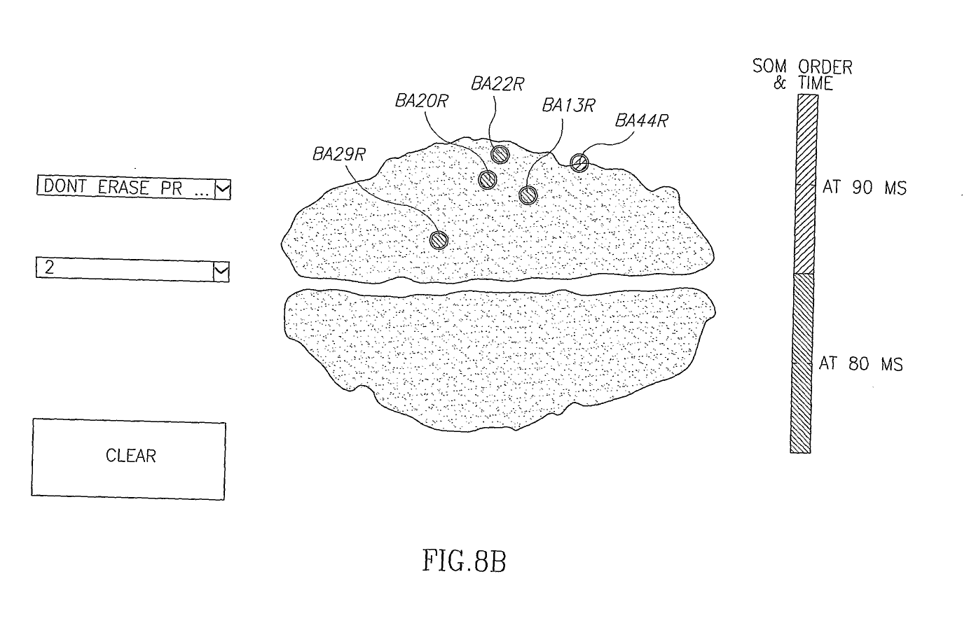

FIGS. 8A and 8B relate to change(s) in the anticipatory pattern of a subject before and after neural feedback performed according to the method of FIG. 6. As shown, there are changes found in FIG. 8B which are not seen in FIG. 8A, relating to a change in the anticipatory pattern between the pre- and post-treatment sessions, which in turn relates to the change in performance and accords with neuropsychological knowledge. This process is an example of a closed loop process for treating a subject.

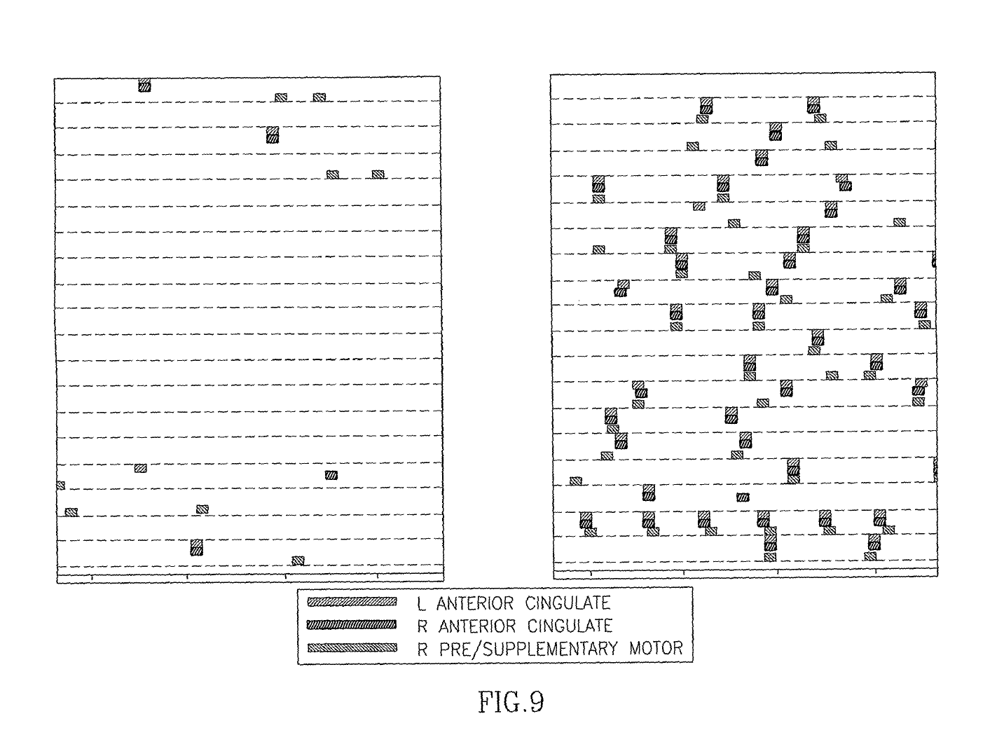

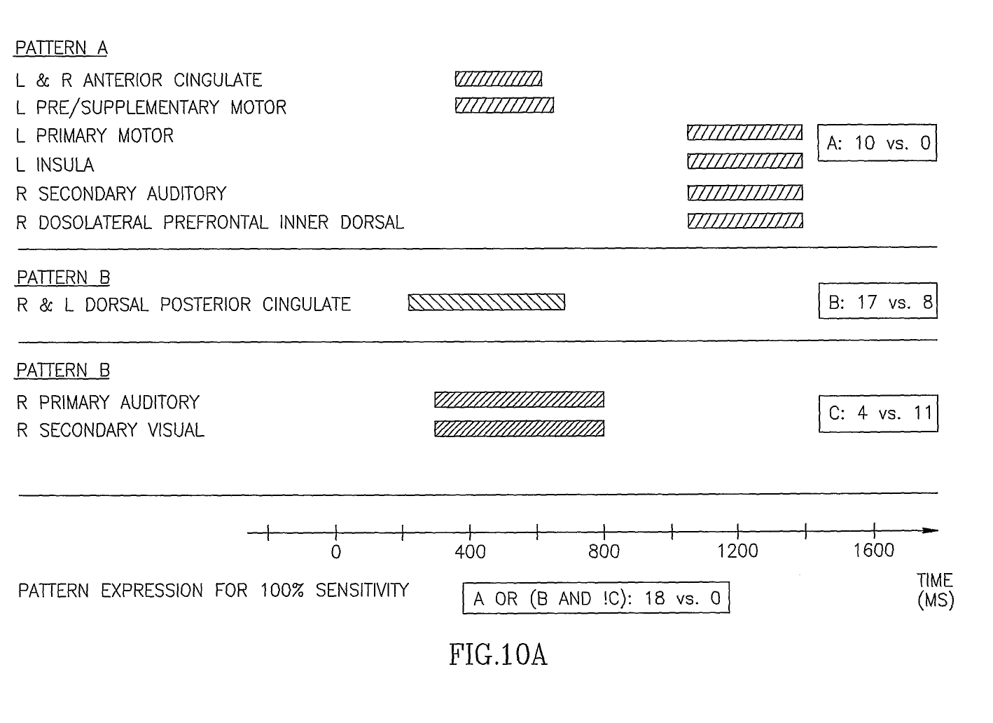

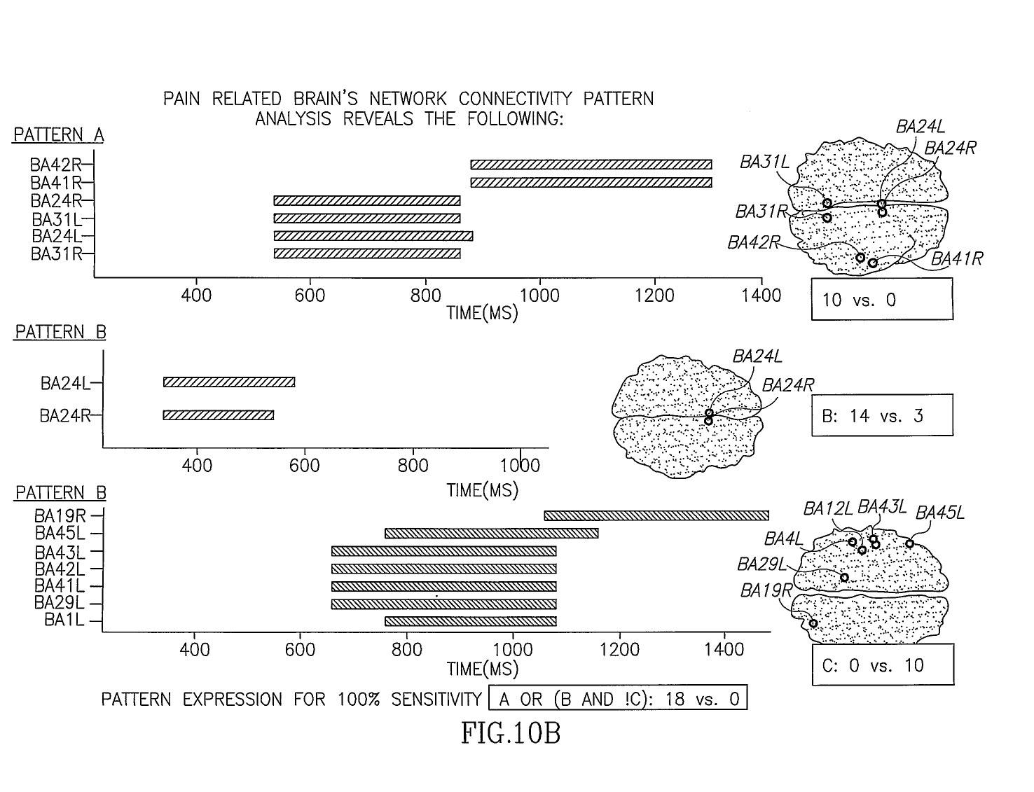

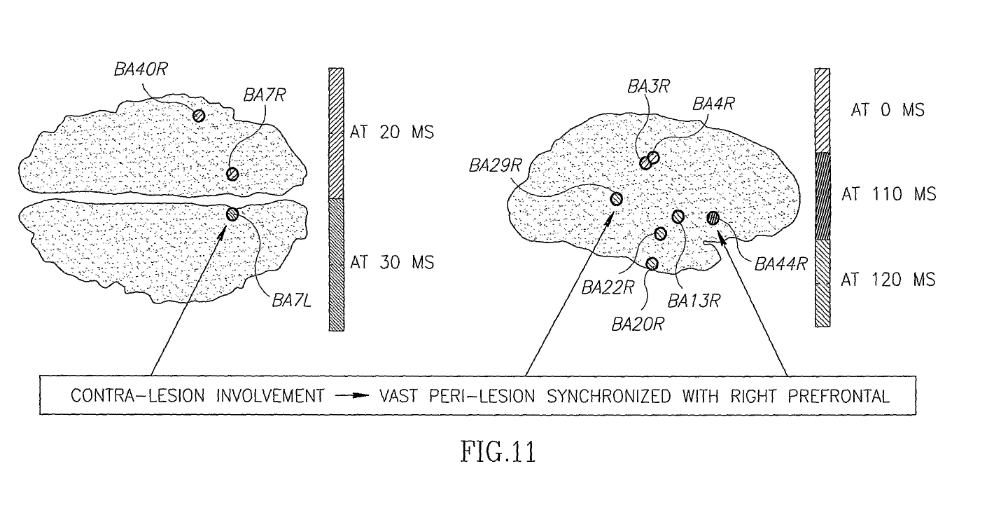

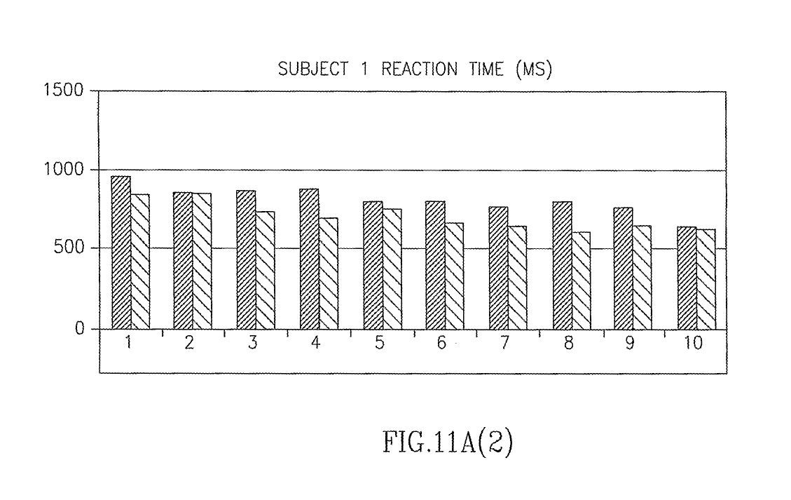

FIG. 9 relates to differences in brain patterns seen in patients without pain (left panel) and suffering from pain (right panel). Clearly such patients with pain have differences in brain activity. However, it is also important to determine which brain activities and hence which brain pattern(s) are related to the presence of pain in the patient. Analysis of the neural connectivity patterns related to brain showed that a particular combination of patterns was found in patients with pain, which were not found in patients without pain. FIG. 10 illustrates these different patterns and their combinations graphically. FIG. 10A shows the patterns of brain activity, while FIG. 10B demonstrates the model that may optionally be determined therefrom.

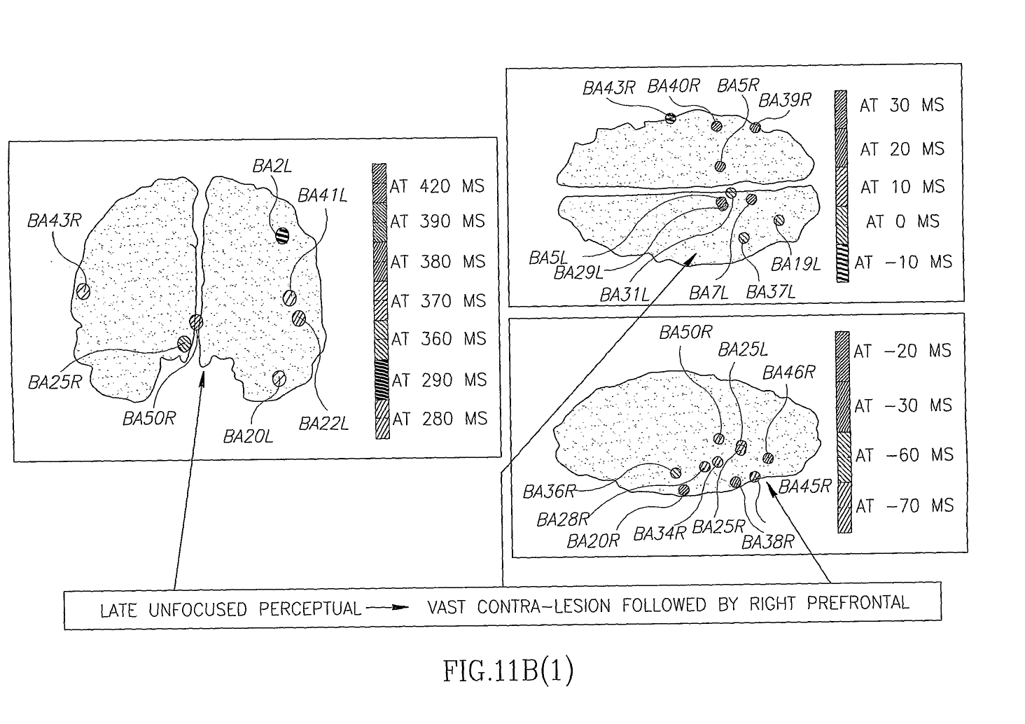

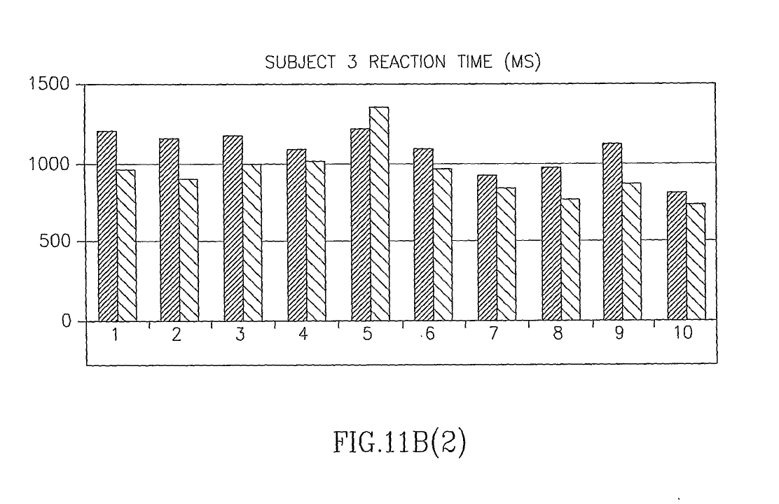

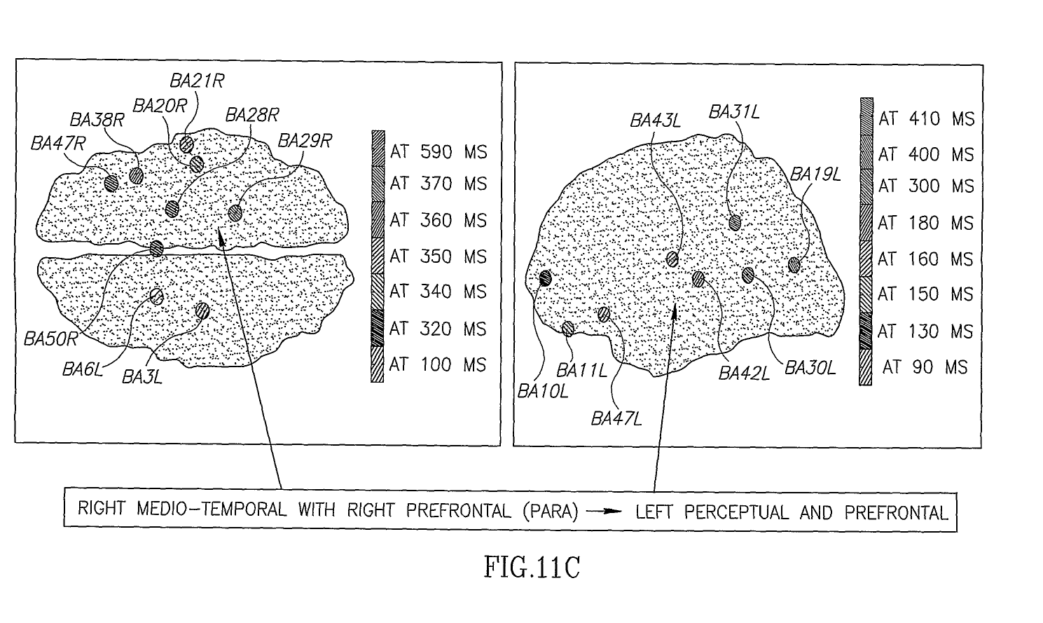

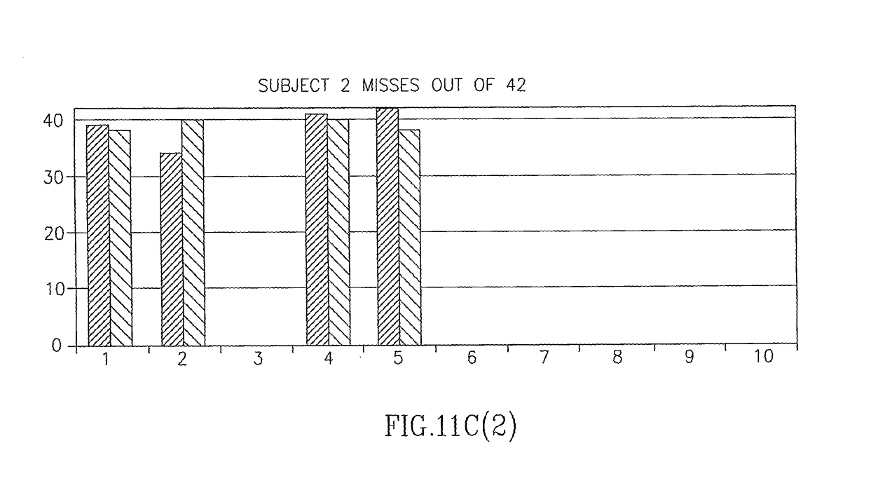

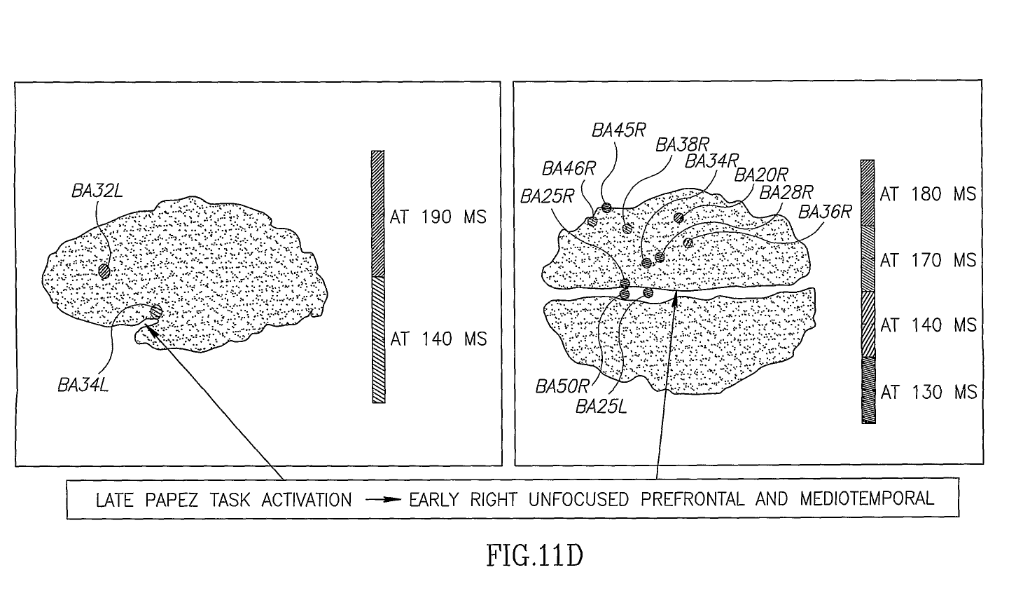

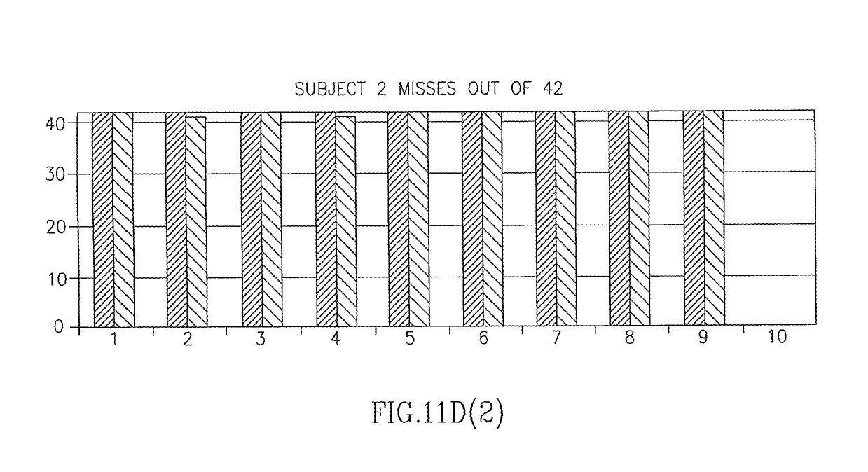

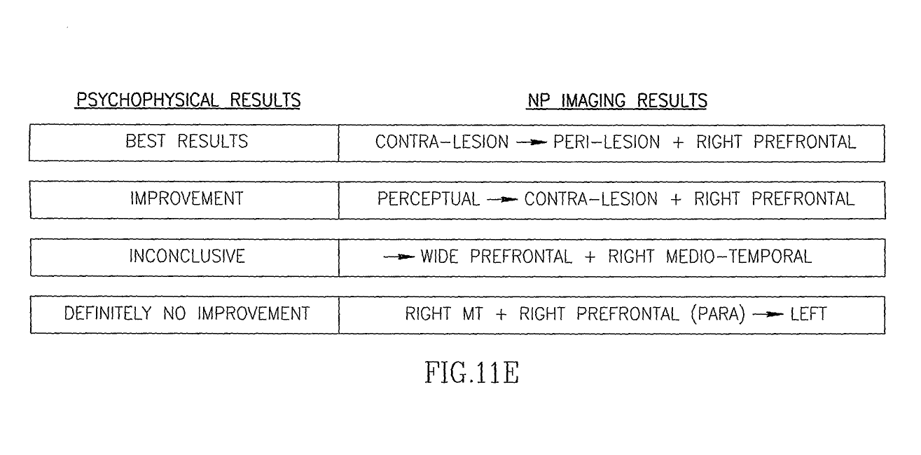

FIG. 11 relates to network changes observed in four patients as a result of treatment with neural feedback. As shown, the best results were obtained from a patient having contra-lesion involvement, showing a vast peri-lesion synchronized with right prefrontal activity (FIG. 11A). The before (left panel) and after (right panel) results show the differences found in the network activity. FIG. 11A(2) shows the reaction time of the subject which clearly improved (for all figures, blue is pre and red is post treatment).

FIG. 11B shows the results for a subject showing some improvement, which can also be seen in the reaction time of the subject in FIG. 11B(2).

FIG. 11C shows the results for a subject having inconclusive results, which can also be seen in the reaction time of the subject in FIG. 11C(2).

The results are summarized in FIG. 11E, which shows a clear correlation between the changes observed in the patterns of brain activity (network changes) and the effect of the treatment in terms of functional outcome.

### Example 1

### Predicting Response of a Patient to Therapy (Hemiparesis)

As noted above, the therapeutic method of the present invention, in various embodiments, has been shown to be highly useful for therapeutic treatment of patients suffering from brain damage or other relevant brain disorder. This Example describes data which demonstrates that the diagnostic method of the present invention, in various embodiments, is highly useful for predicting the ability of a patient to respond to treatment.

Patients suffering from brain damage (specifically hemiparesis) were tested for their ability to perform two different types of tests, “box and block” (BB) test and the “Fugel-Meyer” assessment (FM), both of which are well known in the art. In addition, patients were assessed through the use of EMG (electromyography), which can demonstrate muscle activity even for patients who cannot otherwise move their arm (for example, due to lack of strength or other disability or injury). In contrast, BB and FM tests measure actual physical activity and so rely upon patients having sufficient muscle strength and coordination. Hemiparesis is partial paralysis of one side of the body. A typical (but by no means exclusive) cause of such paralysis is stroke. EEGs were obtained for these patients during the above types of activities.

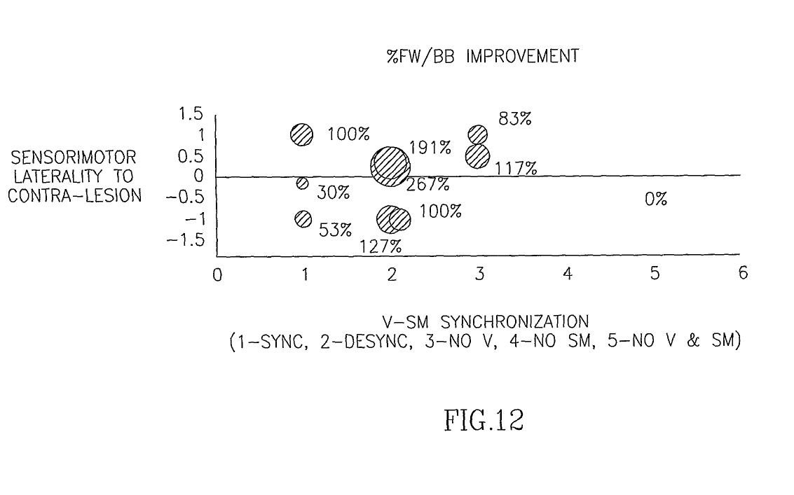

Before treatment started, it was found that the patients could be separated into different groups, based upon the relative abilities of their sensory and visual networks to operate, and also the synchronization between these networks. FIG. 12 shows that the patients can be divided into three different groups: patients in which the sensory and visual networks were both operative but were not synchronized; patients in which the sensory network was less operative than the visual network, but there was synchronization; and patients for whom the opposite was true. It was found that patients in which both networks were operative but not synchronized had the best outcomes, as shown below.

Specifically, FIG. 12 relates to the percent improvement in the FM/BB tests. Patients with the greatest improvement could be found in group 2, in which both networks were active but not synchronized. By contrast, patients in group 1, in which both networks were both active and synchronized, showed less improvement.

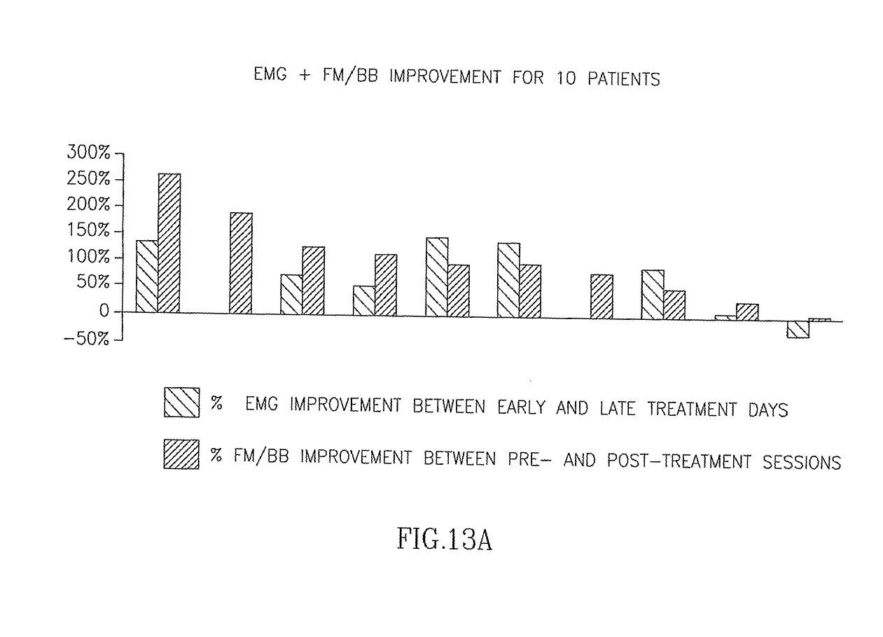

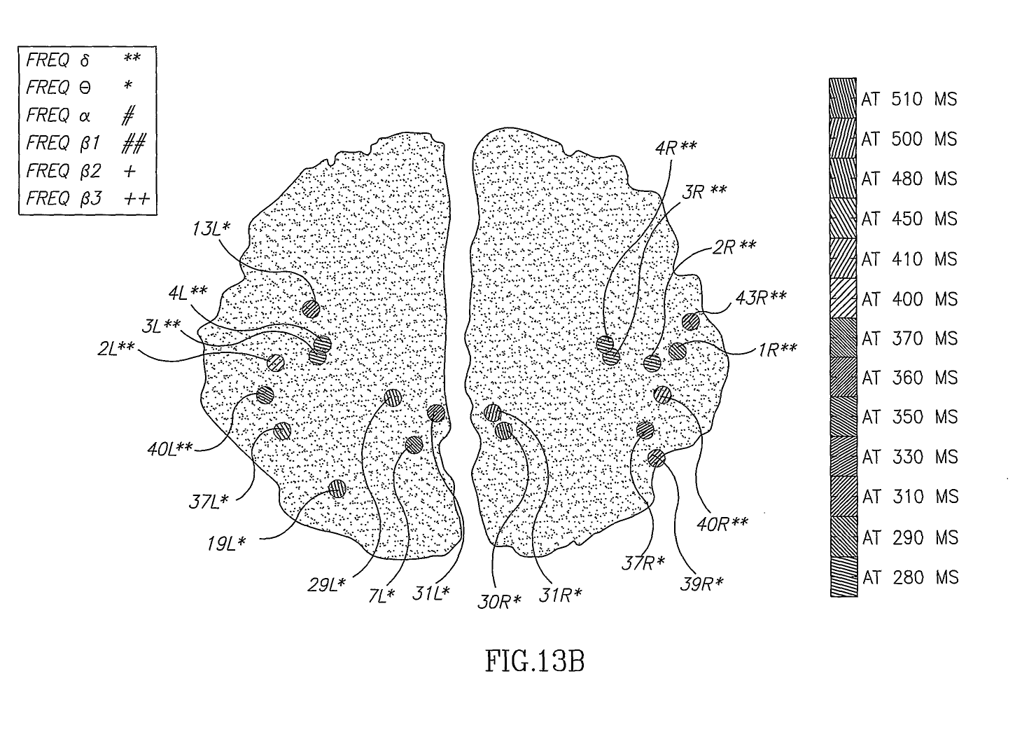

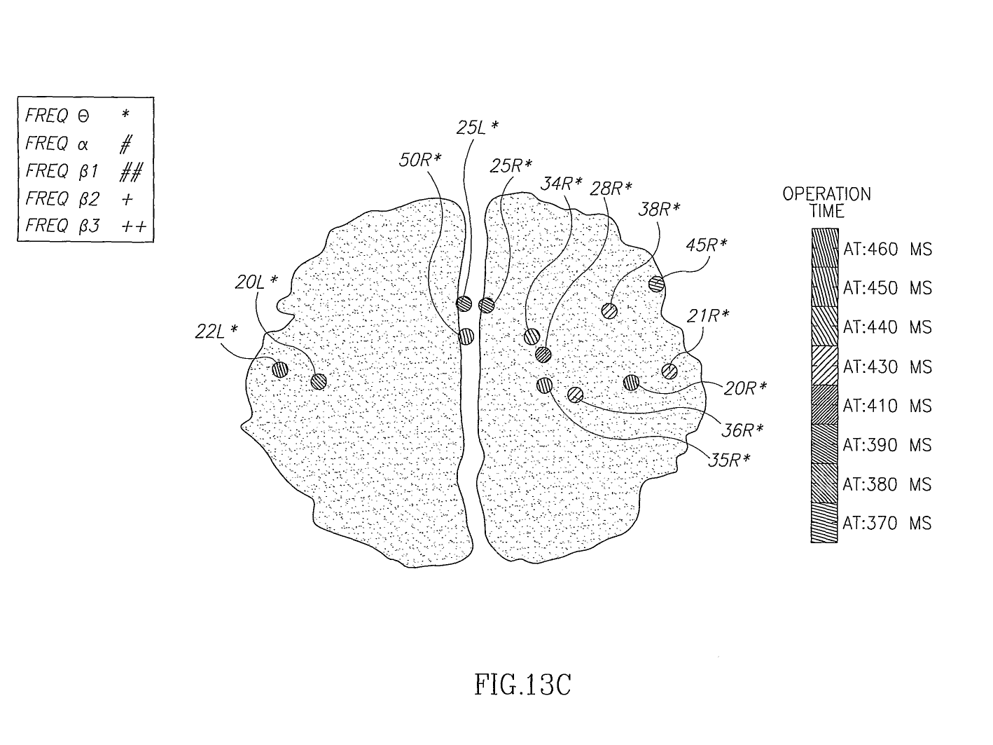

FIG. 13A shows the results for ten patients with right arm paresis who had difficulty reaching for objects with the right arm. It was found that patients who had greater improvement showed either desynchronized (but functional) visual and sensory networks, or else greater contra-lesional (as opposed to ipsi-lesional) activity in sensorimotor regions. FIG. 13B shows the network patterns involved for a patient having both desynchronized visual and sensory networks, and also greater contra-lesional (as opposed to ipsi-lesional) activity in sensorimotor regions. Similar results were found for patients suffering from left arm paresis (not shown). By contrast, FIG. 13C shows that lack of activity of both relevant networks relates to no effective functional improvement (this patient is the last result shown on the bar graph of FIG. 13A).

### Example 2

### Predicting Response of a Patient to Therapy (Neglect)

Hemispatial neglect is a phenomenon in which the patient neglects one side of the body or of the perceived external surroundings; for example, if asked to draw an object, the patient will only draw one side of the object. With regard to the body, a patient may fail to use his or her left arm.

One test that is used to evaluate the severity and type of such neglect is known as BIT (behavioral inattention test), which is a standard test for unilateral visual neglect. Another test is SNT (starry night test) RT (reaction time). The starry night test involves a black background with many points of light, one of which has a different color; the patient must search for the light having the different color. The time required for the patient to locate this light point is the reaction time of the patient for this test. Patients were treated with suitable neural feedback, in order to stimulate the right temporal lobe, which had the lesion or damage that caused the hemispatial neglect.

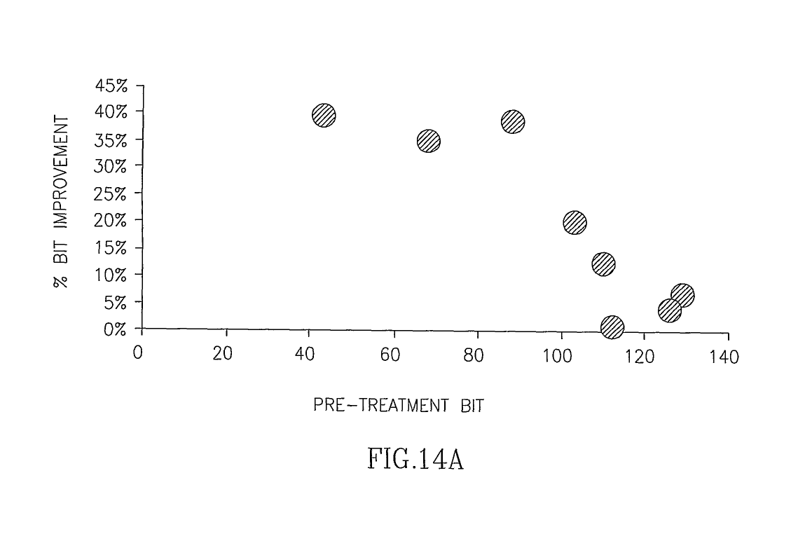

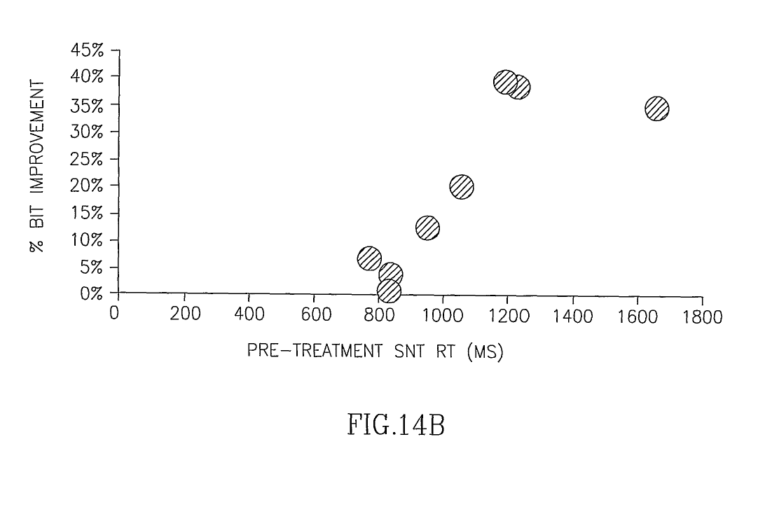

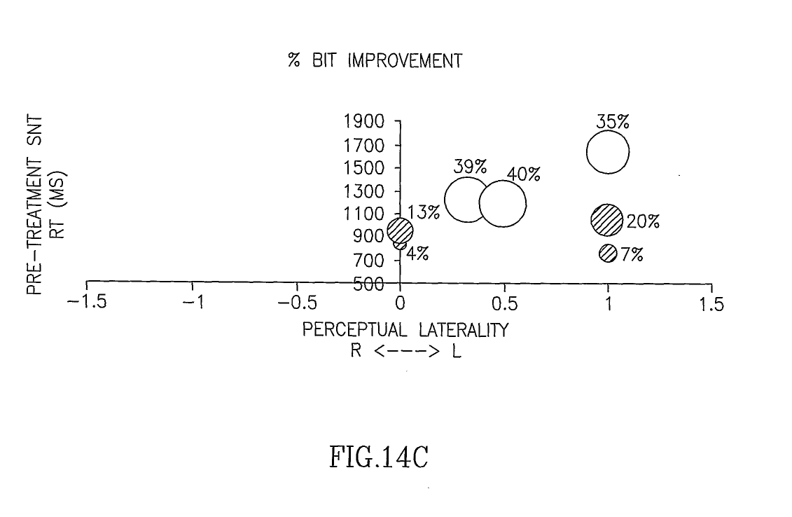

FIGS. 14A-14C relate to the results of pre-treatment BIT and SNT RT measurements. As shown, patients with lower initial BIT scores showed greater percentage in improvement in BIT after treatment (FIG. 14A), which may be expected. However, FIG. 14B shows that patients with higher SNT RT measurements before treatment also showed greater improvement. When these scores are plotted against perceptual laterality, which is the extent to which the deficit manifests itself more to the right or left side in terms of the patient's perception, patients with a certain degree of perceptual left laterality (but not an excessive degree) showed the greatest improvement, as shown in FIG. 14C. Therefore, this type of neural feedback treatment would be expected to have the greatest efficacy for patients with this combination of factors.

For both Examples 1 and 2, the greatest improvements for specific treatments were found to have occurred in patients having a particular combination of factors before treatment started. The efficacy of the treatment was not directly related to the outward physical symptoms or abilities but rather to the neurological state of the patient, with regard to the function network activities that were measured.

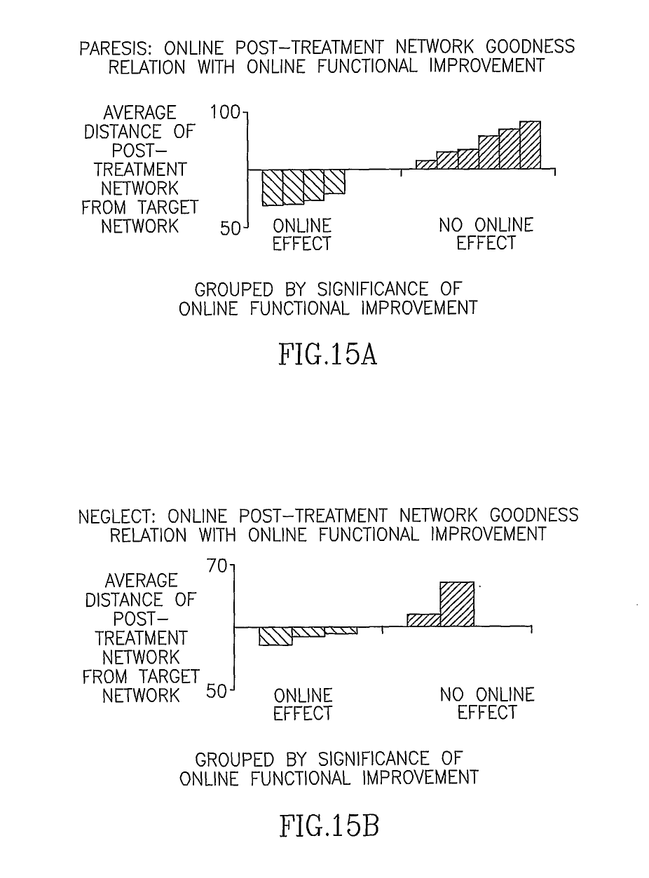

Furthermore, as shown in FIGS. 15A and 15B, the efficacy of treatment correlated with the distance between the target network to be treated and the actual treated network. FIG. 15A relates to the correlation with hemiparesis while FIG. 15B relates to the correlation with neglect. With regard to statistical analysis, a strong correlation was found between the observed and expected networks during short-term treatment period (p<0.00001).

### Example 3

### Correlation of Network Activity with Physical Motor Activity

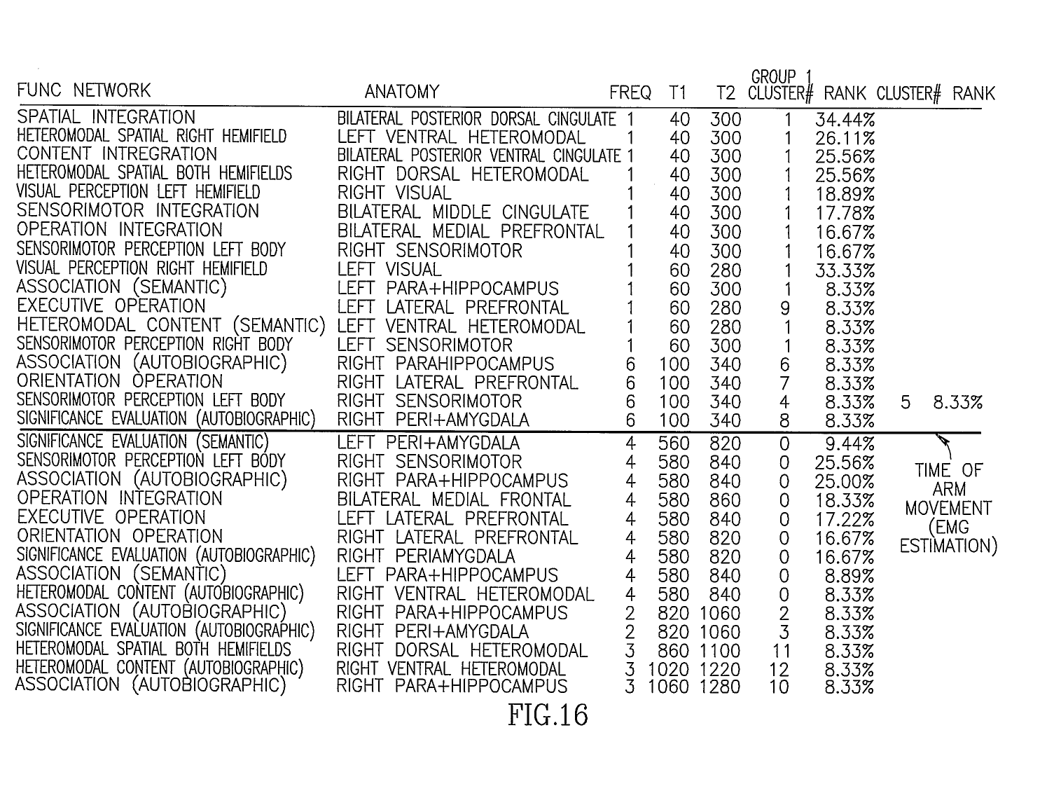

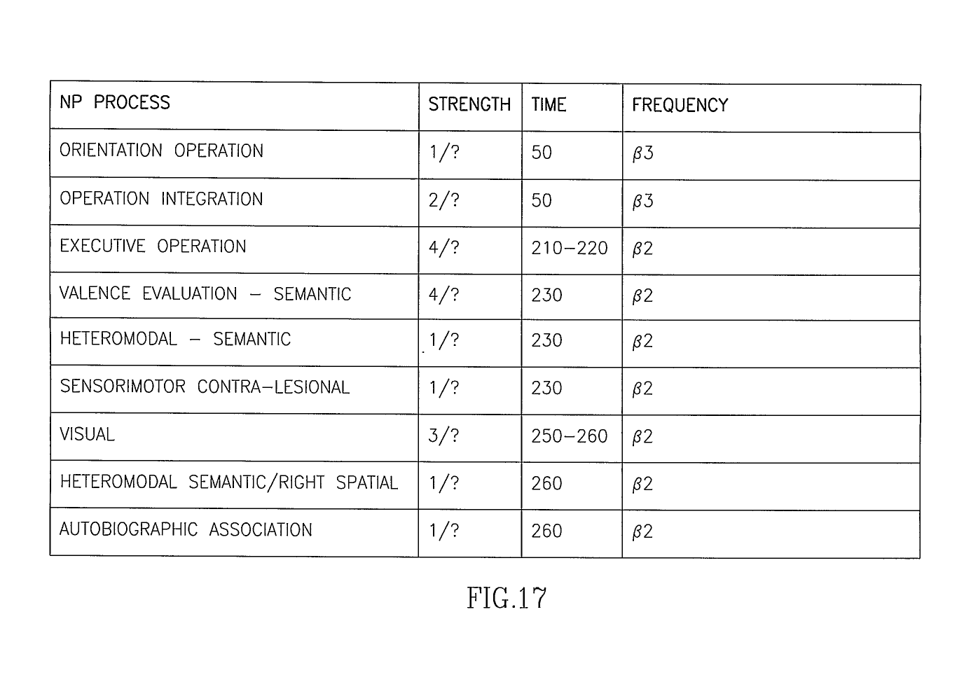

Example 1 related to hemiparesis and testing of the ability of the brain to induce various physical motor activities. During this testing, it was found that the time of receiving the first muscle activation signal, through EMG results, could be correlated with the timing of various network activities. These networks and their activities are shown in FIG. 16; the time of receiving the first muscle activation signal is shown with a blue line. Activities above the blue line occurred before this signal; those below the blue line occurred after the signal. The table shows the functional network, the portion of the brain involved in this network, the frequency of the signal and also the signal timing. Thus, this example shows that the methods of the present invention can also be used to truly correlate physical motor activities with the respective activities of the underlying functional networks.

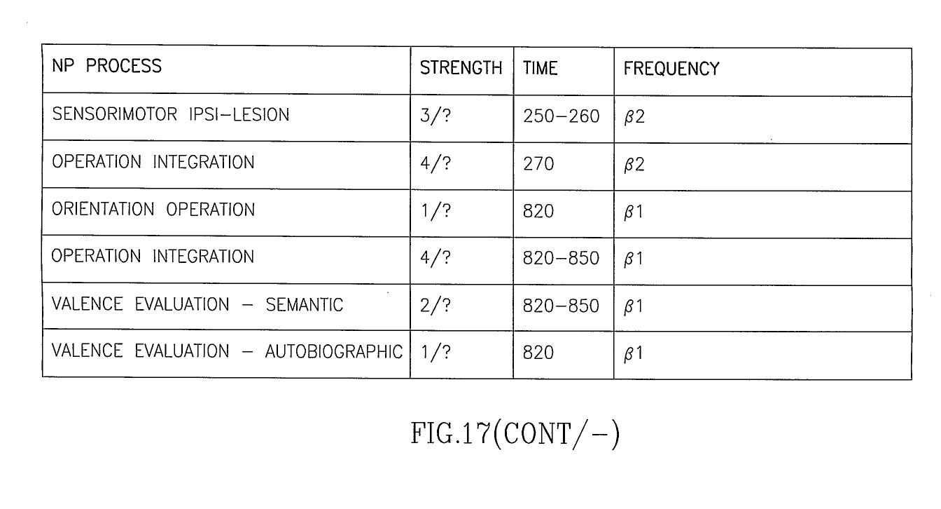

FIG. 17 also demonstrates the ability of the method of the present invention to correlate a neuropsychological process with functional network activation.

The above Examples demonstrate that although various brain disorders and diseases may not yet be truly medically, it is possible to use the methods of the present invention for diagnosis and treatment, by determining the relevant attention components in the tested functional networks. In turn, testing for such components permit better diagnoses and treatments to be made.

The above findings can be expanded to many types of brain disorders and diseases, even if they do not exhibit any gross brain damage (as for example in a patient suffering from a stroke). For example, ADHD is characterized by a number of symptoms, although the underlying brain etiology is not known exactly. This lack of knowledge has hampered accurate diagnosis and also efficacious treatment. The method of the present invention, in various embodiments, permits ADHD to be “defined” according to the functional network(s) and patterns, and also how each operates in patients with ADHD as opposed to those without ADHD, in specific tasks. For example, the relative effects or contributions of different networks for working memory, attention and language can all be adjusted in the ADHD model. This model is expected to be very accurate and predictive, for both diagnosis and also selection of the proper treatment, even if the underlying mechanisms of ADHD are not themselves understood. In this sense, it is possible to describe the method according to the present invention, in various embodiments, as supporting the selection of a plurality of tests, in which the results of these tests combined will enable an accurate diagnosis of ADHD, similar to the manner in which a physician may request a plurality of blood tests for diagnosing a particular disease.

In addition, the present invention supports a new treatment process, in which the patient is treated with a combination of new and known components; the known components can be adjusted for an individual patient. The treatment may be individually adjusted according to the neurological status of the patient, rather than being given because of a general “syndrome”.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While certain features of the present invention have been illustrated and described herein, many modifications, substitutions, changes, and equivalents may occur to those of ordinary skill in the art. It is, therefore, to be understood that the appended claims are intended to cover all such modifications and changes as fall within the true spirit of the present invention.

1-18. (canceled)

19. A method of assessing a neurological state of a subject, comprising:
obtaining neurophysiological data from the subject;
identifying flow patterns in said data and utilizing said patterns for comparison of said data to at least one neural model; and
assessing the neurological state of the subject based on said comparison.

20. The method according to claim 19, further comprising determining brain network activity (BNA) based on said flow patterns, wherein said at least one neural model comprises information pertaining to BNA and wherein said determined BNA are compared to said BNA of said at least one neural model.

21. The method according to claim 19, further comprising repeating said assessment for a plurality of subjects and classifying each subjects according to the respective state.

22. The method according to claim 21, further comprising performing a clinical trial according to said classification.

23. The method according to claim 19, wherein said identification of flow patterns comprises identification of causally related features in said data.

24. The method according to claim 19, wherein said neurophysiological data comprises data acquired while the subject is performing a task.

25. The method according to claim 19, wherein said neurophysiological data comprises data acquired while the subject is conceptualizing a task, but does not perform said task.

26. The method according to claim 25, wherein the subject is incapable of performing one or more voluntary actions.

27. The method according to claim 19, wherein said neurophysiological data comprises data acquired before a treatment and data acquired during and/or after a treatment; and wherein the method further comprises assessing the effect of said treatment.

28. The method according to claim 27, wherein said treatment comprises a pharmacological treatment.

29. The method according to claim 27, wherein said treatment comprises a surgical intervention.

30. The method according to claim 27, wherein said treatment comprises a rehabilitative treatment.

31. The method according to claim 27, wherein said treatment comprises at least one treatment selected from the group consisting of neural feedback, EMG biofeedback, EEG neurofeedback, transcranial magnetic stimulation (TMS) and direct electrode stimulation.

32. The method according to claim 19, wherein said assessing the neurological state comprises assessing level of operation of a sensory network in the brain.

33. The method according to claim 19, wherein said assessing the neurological state comprises assessing level of operation of a visual network in the brain.

34. The method according to claim 19, wherein said assessing the neurological state comprises assessing level of synchronization between a sensory network and a visual in the brain.

35. The method according to claim 19, wherein said assessing the neurological state comprises identifying functional plasticity in the brain.

36. The method according to claim 19, further comprising predicting an effect of a treatment based on said comparison.

37. The method according to claim 19, wherein said neurophysiological data comprises at least one data type selected from the group consisting of EEG data, CT data, PET data, MRI data, fMRI data, ultrasound data, and SPECT data.

38. The method according to claim 19, wherein said neurophysiological data is EEG data.

39. A method of determining the effect of a treatment, comprising:
obtaining EEG data from the subject before and after the treatment;
identifying patterns of causally related features in said data; and
utilizing said patterns for determining the effect of the treatment.

40. A method of predicting an effect of a treatment, comprising:
obtaining EEG data from the subject;
identifying patterns of causally related features in said data; and
utilizing said patterns for predicting an effect of a treatment.

41. A computer software product, comprising a computer-readable medium in which program instructions are stored, which instructions, when read by a computer, cause the computer to obtain neurophysiological data from the subject, identify flow patterns in said data, utilize said patterns for comparison of said data to at least one neural model, and assess the neurological state of the subject based on said comparison.
